(19) United States
(12) Patent Application Publication
(10) Pub. No.: US 2002/0133440 A1
(43) Pub. Date: Sep. 19, 2002

(54) Method of automating the process of purchasing and managing annuities

(75) Inventors: Shane A. Chalke, Leesburg, VA (US); Steven J. Dunlap, Leesburg, VA (US); Kristina Vaughn, Ashburn, VA (US); Thomas E. Christian, Hollywood, MD (US); Thomas E. Dengler, Alexandria, VA (US)

Correspondence Address: Daniel R. Gropper, PC, 9908 Dale Ridge Ct., Vienna, VA, 22181, US

(73) Assignee: AnnuityNet, Inc., Lessburg, VA

(21) Appl. No.: 10/096,465

(22) Filed: Mar. 12, 2002

Related U.S. Application Data
(60) Provisional application No. 60/275,145, filed on Mar. 13, 2001.

(51) Int. Cl. G06F 17/60

(52) U.S. Cl. 705/35

(57) ABSTRACT

A graphical user interface and computer interoperability system for opening and managing annuity contract accounts is taught herein. User entry interview information is requested based on the type of annuity sought. Features include real time error checking and validation, automatic forwarding of completed forms to financial institutions, and automated response and status information from the financial institutions to users. Automated qualification for Registered Investment Advisors is also provided.

### FIELD OF THE INVENTION

An annuity is a contract, sold by a commercial insurance company, that permits the contract owner thereof to accumulate assets that can be used, at a time selected by the contract owner, to pay benefits to the contract owner on a regular basis for the remainder of the annuitant's life or for another specified period of time. Generally the annuitant and contract owner are the same person. The amount of each payment received depends on the performance of the investments made by the contract owner or his/her manager. Underlying each annuity contract are investments in mutual funds, called subaccounts, which in turn invest in stocks, bonds, commercial paper, and government and agency obligations. Investments can also often be made in the insurance company's general account with the insurance company guaranteeing the amount so invested and interest for such investment. Annuity managers regularly rebalance the amount of annuity contract money invested in each type of investment in response to current financial conditions and in anticipation of distributions from the investments.

Until the present invention, the data to open, create and maintain each individual annuity contract had to be reentered for each individual contract. Further, each contract was treated as a separate legal transaction and the information had to be reentered by the financial institution. Linking each contract to a Registered Investment Advisor (RIA) also required work and effort. This entire process of annuity management has been time consuming, expensive and error prone. The methods taught herein are applicable to most financial transactions involving mutual funds, insurance and other financial vehicles.

There are many patents in the field of financial management, but none disclose, alone or in combination, the methods of the instant invention used to automatically create and manage annuity or financial contracts and give real time feedback on the account or contract status.

U.S. Pat. No. 5,765,144 to Larche is a graphical user interface designed for to help the applicant choose credit products and focuses on hypothetical analysis & selection of these products. U.S. Pat. No. 5,523,942 to Tyler teaches a graphical user interface for the selection of various types of insurance products. U.S. Pat. No. 6,064,969 to Haskins teaches fixed annuity projections, but does not provide a platform for annuity creation and servicing.

### SUMMARY OF THE INVENTION

An object of this invention is to provide a graphical user interface based annuity data entry and management platform.

Another object of this invention is to provide a selective interview based on the nature of the annuity sought.

An object of this invention is to provide automated validation of data entered to reduce errors.

An object of this invention is to provide an automated method to forward completed annuity applications to financial institutions.

An object of this invention is to provide automated approval of annuity applications and automated confirmation of the status of annuity applications to the applicant.

An object of this invention is to provide a method for registered investment advisors to be linked to specific annuity contracts.

An object of this invention is to provide real time intraday closing information to annuity managers.

An object of this invention is to provide a means for images of annuity documents and signatures to be forwarded to the financial institution.

An object of this invention is to provide automated email notifications and status reports from the financial institution to the annuity manager.

An object of this invention is to provide a method to automatically rebalance and manage individual and groups of annuity accounts in real time and receive automatic electronic confirmation of the transactions.

### DETAILED DESCRIPTION OF THE INVENTION

Applications for annuities are usually fact and data intensive and the information required varies with the type of annuity sought. Traditionally, applications are completed by hand and then the data is manually input into the financial institution's computer system. There are many opportunities for errors, including wrong or incomplete information provided by the potential annuitant, and by the input of that data into the financial institution's computer system. Additionally, there are many delays built into the system where the same data has to be manually input at numerous steps in the process. These methods of doing business have made the annuity business traditionally expensive and error prone. The instant invention provides a system and method to automate not only the annuity contracting process, but also the annuity validation, issuance, management and status process.

While three block diagrammatic computer systems are discussed herein, it will be understood that the instant invention can also be practiced on one or two computer systems, now known, or hereinafter developed, that have the functionality of the three block diagrammatically defined computer systems. Additionally, the three block diagrammatically defined computer systems can inter-communicate by any now known, or hereinafter developed communication system, including, but not limited to twisted pair, fiber optic, and cable systems.

A graphical user interface is employed to make data entry and operation of the system as easy as possible for the annuitant or annuity manager. The graphical user interface is operated on the first computer system. An interview is conducted, via the graphical user interface (GUI), on the first computer system to obtain the necessary information from the user. The interactive interview requests only pre-selected data to be processed based on the type of annuity being created or managed. The type of annuity is selected by the potential user through making choices through the GUI on the first computer system.

The first computer system is in communication contact with a second computer system, which controls the nature and interaction of the GUI on the first computer system.

The second computer system is, in turn, in communication contact with a third computer system, which is usually operated by the financial institution which may issue the annuity. The third computer systems are often of older types, sometimes called legacy, and require a second computer system, as described herein, to provide the interface with the GUI users on the first computer system.

Data entered on the first computer system is pre-screened and validated by the second computer system either in real time or on when a GUI page on the first computer is uploaded to the second computer.

When the second computer system has received the pre-screened and validated information about the annuity, the second computer system translates and reformats the data received from the GUI of the first computer system and sends it, via various communications systems, now known or hereinafter developed, to the third computer system for processing by the financial institution.

Many parts of the process can take place in real time or almost real time, such as the ability of the second and/or third computer system to provide information back to the first computer system of the instantaneous status of the pending transaction. Such information can include data such as a transaction number, the status of whether an annuity application has been accepted by the financial institution, and whether further information is required.

Depending on the configuration and technical requirements of the first, second and third computer systems, the pending transaction may be stored and placed in a processing cue on the first, second or third computer systems. The financial institution, using the third computer system to access the second and/or first computer systems, can then automatically review the pending application data electronically. This permits potential users to enter the information at virtually any time and they are not limited to entering the information at the times the financial institution is open for business. This permits a financial institution to do business virtually around the clock and around the world without having offices open 24 hours a day. This alone will provide great savings and flexibility.

Approvals, requests for further information and customer status and management inquiries can travel automatically between the user's GUI interface and the first, second and third computer systems. The third computer system can act as a gatekeeper and selectively process and access pending transactions in accordance with pre-selected criteria for operational efficiency on a batch mode basis.

In certain circumstances, the second computer can be configured to operate as a defacto third party administrator for the annuity issuing financial institution.

A key factor to the efficiency of the herein-described system is the automatic validation and verification of the data input into the first computer system. Such validation can be implemented through the use of common object model components.

Additionally, due to the vast array of computer systems operated by financial institutions, various software applications, called middleware, may be implemented to facilitate communication between the first, second and third computer systems. Such middleware may communicate using Common Object Request Broker Architecture (CORBA) based software applications. Such middleware software applications will permit the first, second and third computer systems to communicate and interact automatically.

Many times either original (wet) or images of complete documents and/or signatures, or other proof of identification are required by the financial institution. With current technology, and/or future developed technology, whole signed documents, photographs, finger prints, iris scans and other identifying information may be input through the GUI and made part of the application file and forward from the first computer system to the second and third computer systems to become part of the official record of the transaction.

Often, after the information has been entered and validated through the GUI on the first computer system, it can be locally downloaded and printed out in hard copy by the first computer system for record keeping by the potential annuitant, and/or for hard copy submission to the financial institution.

The first, second and third computer systems can be configured to provide instantaneous notifications of status messages by various means, including, but not limited to email, telephone and hard copy.

In addition to providing means to create annuity accounts, the system taught herein also provides the means to manage annuity account functions, real time and on line. Most managerial and operational annuity functions can be performed through the first, second and third computer systems such as notifications of intraday trade closing times for individual funds and execution of trades and the rebalancing of various accounts within each annuity. Since the computer systems are linked, real time status is available to the end user via the GUI on the first computer system with information provided by the second and third computer systems.

The process described herein makes the incredibly complex annuity management functions manageable. The validation process eliminates unprocessable requests at the time of submission. All of the math is correct, including for such important fields as the percentage of the required balances in each account. Standard information, such as zip codes, are matched to the name of the city input into the application. Even when transactions are input on nights and holidays, there is a high probability of success as the information input into the GUI is prescreened.

The system can be configured to automate the time and resource intensive process of linking registered investment advisors with specific contracts, including processing the limited power of attorney.

The system can automate passwords and other methods of authentication for the registered investment advisor to be able to take actions with respect to the operation and management of the annuities. The registered investment advisor manages clients online through the GUI and all annuity information is available online. Individual and groups of annuity contracts can be managed by the registered investment advisor through the GUI. The same information appearing in multiple contracts no longer needs to be manually entered. Many normal banking transactions, concerning the management of the annuities, can be facilitated by the system including, but not limited to electronic fund transfers, fee debiting permissions by contract and by schedule, transaction history by contract, fund transfers by contract, fund rebalances by contract, scheduled rebalances by contract, future allocation changes, scheduled dollar cost averaging by contract, group fund transfers, group scheduled rebalance programs and group dollar cost averaging programs.

The systems described herein can handle individual or groups of annuities at one time.

The system described herein had numerous benefits over previous system, including less paper required for each transaction, faster approvals, and little human labor required. This system is scaleable and provides improved annuity management tools for the registered investment advisor including providing comprehensive annuity information which is always up-to-date.

It is to be understood that while certain forms of the present invention have been described herein, it is not to be limited to the specific forms or arrangement of method described and shown and herein and other forms of the invention can be practiced as taught herein without departing from the nature and spirit of the invention.

What we claim is:

1. An automatic method for purchasing and managing annuities comprising:
a) A first computer system, configured to accept the entry of annuity creation or maintenance data, through a graphical user interface;
b) A second computer system, in communication with said first computer system, wherein said second computer system conducts, through said graphical user interface on said first computer system, an interview process requesting only pre-selected data to be processed based on a variety of factors, including annuity type, solicitation state, and plan type being created or managed, as selected on said first computer system;
c) A third computer system, in communication with said second communication system, which is operated by annuity processing financial institutions;
d) Wherein said second computer system, through said a graphical interface on said first computer system, prescreens annuity data for errors or omissions and then forwards said prescreened data to said third computer system; and,
e) wherein said second computer system then receives processed data from said third computer system and formats said processed data and forwards said formatted and processed data to said graphical user interface of said first computer system.

2. An automatic method for purchasing and managing annuities, as recited in claim 1, wherein
said first computer system validates said annuity data upon entry into said first computer system.

3. An automatic method for purchasing and managing annuities, as recited in claim 1, wherein
said annuity data is validated upon upload from said first computer system to said second computer system.

4. An automatic method for purchasing and managing annuities, as recited in claim 1, wherein
a pending transaction tracking number is displayed on said graphical user interface of said first computer system upon success entry and forwarding of said annuity data to said second and/or third computer systems.

5. An automatic method for purchasing and managing annuities, as recited in claim 1, wherein said pending annuity data is stored electronically in a transactional workflow queue.

6. An automatic method for purchasing and managing annuities, as recited in claim 1, wherein said pending annuity data, stored on said second computer system, may be reviewed by said annuity processing financial institutions through said third computer system.

7. An automatic method for purchasing and managing annuities, as recited in claim 1, wherein approval of annuities may be input by said annuity processing financial institutions through said third computer system and forwarded to said first computer system through said second computer system.

8. An automatic method for purchasing and managing annuities, as recited in claim 7, wherein approval of annuities may be input by said annuity processing financial institutions through said third computer system and forwarded to said first computer system through said second computer system in real time.

9. An automatic method for purchasing and managing annuities, as recited in claim 1, wherein said annuity processing financial institutions, through said third computer system, can selectively access and process pending transactional annuity data disposed on said second computer system.

10. An automatic method for purchasing and managing annuities, as recited in claim 1, wherein said second computer system is configured to function as a third party administrator for said financial institution.

11. An automatic method for purchasing and managing annuities, as recited in claim 1, wherein said validation of said annuity data is performed utilizing common object model components.

12. An automatic method for purchasing and managing annuities, as recited in claim 1, wherein said second and third computer systems communicate using a variety of middleware software applications.

13. An automatic method for purchasing and managing annuities, as recited in claim 12, wherein said second and third computer systems communicate using Common Object Request Broker Architecture (CORBA) software applications.

14. An automatic method for purchasing and managing annuities, as recited in claim 1, further comprising software applications wherein said second and third computer systems can communicate and interact automatically.

15. An automatic method for purchasing and managing annuities, as recited in claim 1, wherein images of documents and signatures are forwarded from computer said first computer system to said second computer system to said third computer system for authentication.

16. An automatic method for purchasing and managing annuities, as recited in claim 1, wherein completed forms, containing said validated annuity data entered into said first computer system, are made available for downloading and printing on said first, second and third computer systems.

17. An automatic method for purchasing and managing annuities, as recited in claim 1, further comprising automated email notifications of transaction status to said computer systems one, two and three.

18. An automatic method for purchasing and managing annuities, as recited in claim 1, further comprising real time notification, of intraday trading closing times.

19. An automatic method for purchasing and managing annuities, as recited in claim 1, wherein registered investment advisors can, through said first, second and third computer systems, be authenticated and linked with particular annuity contracts.

20. An automatic method for purchasing and managing annuities, as recited in claim 1, wherein most annuity operational and management operations can be performed from said first, second and third computer systems.

21. An automatic method for purchasing and managing annuities, as recited in claim 1, wherein fund rebalancing can be performed from said first, second and third computer systems.

22. An automatic method for purchasing and managing annuities, as recited in claim 1, wherein fund status is available on line from said first, second and third computer systems.
